(19) United States
(12) Patent Application Publication
(10) Pub. No.: US 2011/0081051 A1
(43) Pub. Date: Apr. 7, 2011

(54) AUTOMATED QUALITY AND USABILITY ASSESSMENT OF SCANNED DOCUMENTS

(75) Inventors: Arun Tayal, Chennai (IN); Puja Lal, Chennai (IN); Pramod Kumar, Chennai (IN); Saba Naqvi, Chennai (IN); Shubhanshu Srivastava, Chennai (IN); Virender Jeet, Chennai (IN)

(73) Assignee: NEWGEN SOFTWARE TECHNOLOGIES LTD., Chennai (IN)

(21) Appl. No.: 12/714,111

(22) Filed: Feb. 26, 2010

(30) Foreign Application Priority Data
Oct. 6, 2009 (IN) 2427/CHE/2009

(51) Int. Cl. G06K 9/00

(52) U.S. Cl. 382/112

(57) ABSTRACT

The present disclosure refers to automated quality and usability assessment of scanned documents and illustrates embodiments pertaining to systems and methods utilized to achieve the same. The system comprises a user interface, a document analyzer coupled to the user interface, an error monitor coupled to the document analyzer and a usability processor coupled to the error monitor. The user interface enables a user to input intended purpose of scanned document as well as pre-determined parameters such as touching characters, broken characters, font height, density, too-dark, too-light, photo in B&W document, font to assess the quality of the scanned document etc.. The document analyzer is configured to analyze and ascertain whether the scanned document is in an appropriate format in accordance with the intended purpose of the scanned document. The error monitor further comprises a usability error identification unit, a page error identification unit, a scanner identification unit and a tangible error identification unit. The usability processor further comprises a text identification unit, a textual processing unit coupled to the text identification unit and an analysis unit coupled to the textual processing unit and an image analysis unit.

### TECHNICAL FIELD

The present disclosure relates assessment of electronic documents such as documents captured through scanner or a digital camera and more specifically, but not limited to, automated quality assessment of scanned documents.

### BACKGROUND

The terms ‘scanned image’, ‘scanned image of document’ and ‘scanned document’ have been used interchangeably throughout the present disclosure as they merely refer to documents which have been scanned.

Historically, every industry such as Banking, telecom, Insurance, Government services, Manufacturing and Education have relied heavily on paper based documents. Even with the advent of computers and technological advancements, the demand for paper for usage in day to day operations remains the unaltered. However, owing to a few companies who have taken lead in converting paper documents to electronic documents using imaging technologies, a number of companies have shifted to the practice of scanning their documents and utilizing the document images for their day to day operations.

Scanned documents, being in the digital form, are more convenient to be sent to and receiving from different physical locations. In addition, as the documents take electronic form, the physical documents can be much easily and conveniently stored for posterity and future use. This also saves the document storage costs and virtually eliminates the need to photocopy the same document multiple times for different users. Scanned documents also facilitate easy methods of retrieving, handling, processing, archiving, etc., even if the document volume is huge. Clearly, conversion of paper documents to electronic format results in huge cost savings for the companies and manifold increase in efficiency and productivity due to streamlined operations. Consequently, establishments see scanning as a non-core activity that requiring large number of dedicated resources. Therefore, establishments outsource the document scanning activity to specialist vendors. More and more companies, cutting across the industries, are choosing to outsource scanning activities, and thereby delineating their core focus areas from non-prime/support areas. These vendors dedicatedly scan documents, and have established massive scanning infrastructure for scanning documents in bulk.

Companies/scanning centers to which document-scanning operations are outsourced provide specialist solutions. They have hundreds of scanners and operators working in parallel round-the-clock doing only scanning. This works out to be a much-more cost effective and resource-effective option for companies outsourcing their work. Businesses achieve multiple benefits like increased efficiency, faster response times, better customer services, greater business agility and lower costs. The scanning centers to which the job is outsourced has clients catering to different fields and industries, such as banks, educational institutes, etc. and thus their requirements vary accordingly. For example, banks and insurance companies need to preserve the scanned documents for long periods of time as against an educational institute, which may need to preserve individual scanned documents for relatively shorter durations. Similarly, while the primary purpose of scanned answer sheets is data extraction, a residence proof document is just needed for storing as a supplement document for issuing credit card. A bank or a Telecom form has a customer photograph attached onto them for future reference processes. As bank needs to identify the customer for all his future transactions, a loan processing or a cash withdrawal, photograph serves as a major entity of identification. In a telecom company, for security purposes, the identity verification of the user is performed along with other personal verifications. For all such scenarios, the photograph of the user should be scanned such that the customer is clearly identifiable through the photograph. However, often such documents/forms are scanned in black-&-white, which does not solve the purpose. It might at times be required to scan these forms in gray-scale or color depending upon their usage. There is no validation at this stage to check the quality of the scanned document before it enters the process of the bank or the telecom company. The same kind of problem is faced by almost all businesses very often.

Also, outsourcing scanning has its share of problems. Every organization outsourcing their scanning work needs scanned documents for specific purpose. A scanned document is used either for later referring/viewing it or for automatic extraction of data from it. If the document needs only to be viewed, the document can be scanned at a lower resolution (lower DPI). However, if the scanned document is to be used for extracting data from (OCR, OMR, ICR, Barcode, MICR, etc.), the document needs to be processed at higher resolution (higher DPI). The scan quality has a direct impact on the size of the scanned document.

As the scanned image is meant to be a substitute of the Physical copy of the document, the readability index of the document becomes the most critical thing in the entire process. Readability index defines the degree of readability of a document. Higher readability index means better legibility and ease in reading. Reading could be done by human eye or by software for OCR, ICR/OMR, MICR or other type of data recognition.

While human eye can read even low quality scanned image, a character based recognition software needs higher quality scanned image. Depending on the readability index, a document may be classified as being scanned only for viewing purpose, or satisfying the quality criteria for printing or maybe data extraction purpose as well. Therefore, readability index is directly dependent on the various features of scanned text like density, font height, touching character index, broken character index and resolution at which the document is scanned.

Several mechanisms are presently available which look into the issue of quality of a scanned document. These mechanisms primarily aim to enhance the quality of the scanned images as a pre-processing step. However, such enhancement is applied to an entire batch of documents rather than enhancing only those documents which require better quality image. Also, identifying the documents which require enhancement of their quality image shall require manual intervention which proves to be inconvenient.

Further, existing mechanisms check the quality of the scanned document against the actual document. Such Quality check mechanisms are carried out by randomly selecting scanned documents and checking them manually against original documents. Incase any non-compliance is identified; the entire batch of documents is rejected and sent back for re-scanning Also, quality perception varies from person to person, therefore, one person may perceive a document as compliant with the original document while another may not. Therefore, again on basis of perception an entire batch is rejected which adds to cost and effort required. Thus, the process adds to the overhead of the business as it involves a whole batch of documents instead of selecting the problematic document and rescanning it.

Also, all automated mechanisms process documents on the basis of a few parameters such as resolution, excessive noise etc. These features act as pre-quality checkers for the scanned document but do not check the document for suitability in accordance with their usage.

There are specific mechanisms available in the field of image processing such as IQA (Image Quality Assurance) and VRS (Virtual Rescanning). However, these mechanisms are related to specific purposes only such as IQA is specific to cheques only and cannot be used for other type of documents while VRS depending on the quality of the scanned documents, improves the quality of documents scanned without actually again scanning the document.

### SUMMARY

Embodiments of the present disclosure refer to system and method for automated quality assessment of scanned documents which does not enhance but merely assesses the quality of a scanned document.

An embodiment of the present disclosure refers to a system for automated quality assessment of scanned documents. The system comprises a user interface, a document analyzer coupled to the user interface, an error monitor coupled to the document analyzer and a usability processor coupled to the error monitor. The user interface enables a user to input intended purpose of scanned document as well as pre-determined parameters such as touching characters, font height, density, too-dark, too-light, font etc. to assess the quality of the scanned document. These parameters are configurable by the user as and when required. According to another embodiment, the user describes and configures the system for a particular batch of documents or some specific documents within the batch based on its usability. The document analyzer is configured to analyze and ascertain whether the scanned document is in an appropriate format in accordance with the intended purpose of the scanned document. The error monitor further comprises a usability error identification unit, a page error identification unit, a scanner identification unit and a tangible error identification unit. The usability processor further comprises a text identification unit, a textual processing unit coupled to the text identification unit and an analysis unit coupled to the textual processing unit.

The usability processor unit will check for usability of document for purpose specified by user in user interface. The document can be intended for photo identification purpose, for readable purpose, for printing purpose etc. If the user specifies the intended usage as readable, then the readability index of the scanned document is checked. If the user specifies the intended usage as printing and reading then along with screen readability the print readability index is also checked.

The intended usage can also be OCRing, for this the OCR index is checked. The OCR index will be calculated intelligently by analyzing the text block of documents and without actually OCring the document

If the intended usage is photo identification, then the system checks whether any photo is present in B&W image. It will also check for photo quality if the document is scanned in Color or Gray.

According to another embodiment of the present disclosure, a system for automated quality assessment of scanned documents comprises a user interface, a document analyzer coupled to the user interface and a training module coupled to the document analyzer. As in the previous embodiment, the user interface enables a user to input intended purpose of scanned document as well as pre-determined parameters such as touching characters, font height, density, font to assess quality of scanned documents. The document analyzer is configured to analyze and ascertain whether the scanned document is in an appropriate format in accordance with the intended purpose of scanned document. The training module further comprises a manual error check unit, a manual usability processor coupled to the manual error check unit and a memory unit coupled to the manual usability processor. On completion of training of the system via the training module, the system operates automatically wherein no manual intervention is required.

Yet another embodiment of the present disclosure refers to a scanner which comprises a user interface, a document analyzer coupled to the user interface, an error monitor coupled to the document analyzer and a usability processor coupled to the error monitor. The user interface enables a user to input intended purpose of scanned document as well as pre-determined parameters such as touching characters, font height, density, too-dark, too-light, font etc. to assess the quality of the scanned document. These parameters are configurable by the user as and when required. According to another embodiment, the user describes and configures the scanner for a particular batch of documents or some specific documents within the batch based on its usability. The document analyzer is configured to analyze and ascertain whether the scanned document is in an appropriate format in accordance with the intended purpose of the scanned document. The error monitor further comprises a usability error identification unit, a page error identification unit, a scanner identification unit and a tangible error identification unit. The usability processor further comprises a text identification unit, a textual processing unit coupled to the text identification unit and an analysis unit coupled to the textual processing unit.

According to yet another embodiment further to the embodiment mentioned above, the usability processor additionally comprises a photo assessment unit wherein the photo assessment unit comprises a black and white detection unit and a photo quality analysis unit. The photo assessment unit is used for application where the identity of a user is to be verified and therefore, would require the photograph to be in color than black and white.

Another embodiment of the present disclosure refers to a method for automated quality assessment of scanned documents. The method comprises inputting scanned paper document, determining whether the scanned document is in an appropriate format in accordance with the intended purposes of the scanned document. If the scanned document is in appropriate format, then identifying any errors in the scanned document. If errors exist, then send the paper document for rescanning and repeating the aforementioned step. Further, if there are no errors identified in the scanned document then determine whether the scanned document qualifies the usability index else send the paper document for rescanning and repeating the aforementioned step. If the scanned document qualifies the usability index then approve and accept the scanned document. In accordance with an embodiment of the present disclosure, the errors in a scanned document are identified by identifying usability errors, page errors, scanner errors and tangible errors. According to yet another embodiment of the present disclosure, verification of the readability index is achieved by intelligently identifying textual blocks from the scanned document, processing textual blocks as identified and analyzing the processed textual block to determine whether the text is readable or not. The text blocks are processed by determining the width, height and density of the textual block and segregating textual blocks with smaller font. In accordance with an another embodiment of the present disclosure, the method for automated quality assessment of scanned documents comprises inputting and scanning paper document, analyzing scanned document to ascertain quality parameters, identifying errors in scanned document manually, determining usability i.e. readability and detect photo, of scanned document manually and storing settings implemented manually for future reference in the training module of the system. Consequent to the training of the system via the training module for a few initial batches of documents for scanning, the system becomes automatic as described in the first embodiment of the disclosure.

### BRIEF DESCRIPTION

The detailed description is described with reference to the accompanying figures. In the figures, the left-most digit(s) of a reference number identifies the figure in which the reference number first appears. The same numbers are used throughout the drawings to reference like features and components.

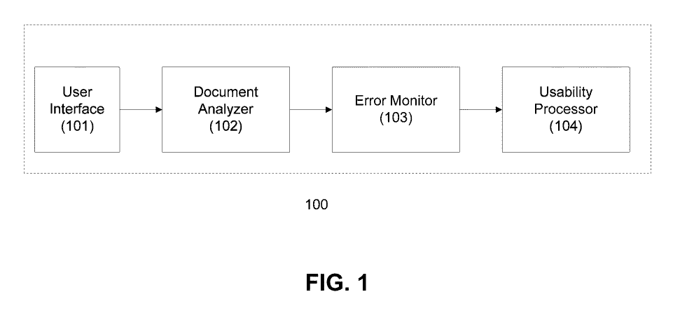

FIG. 1 illustrates a diagrammatic representation of a system for automated quality assessment of scanned documents in accordance with an embodiment of the present disclosure.

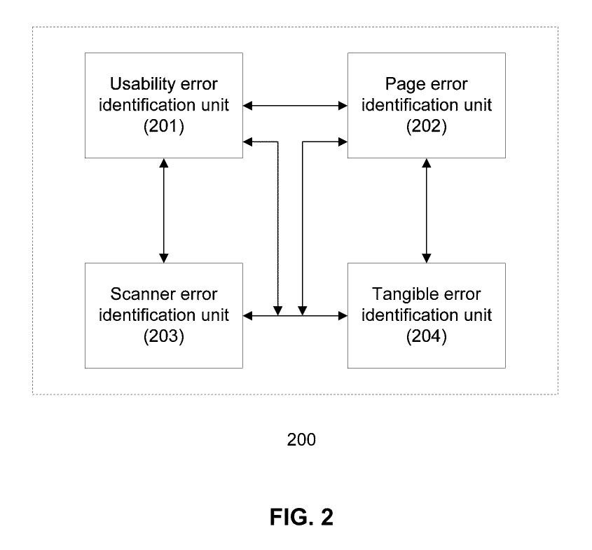

FIG. 2 illustrates a diagrammatic representation of an error monitor in accordance with an embodiment of the present disclosure.

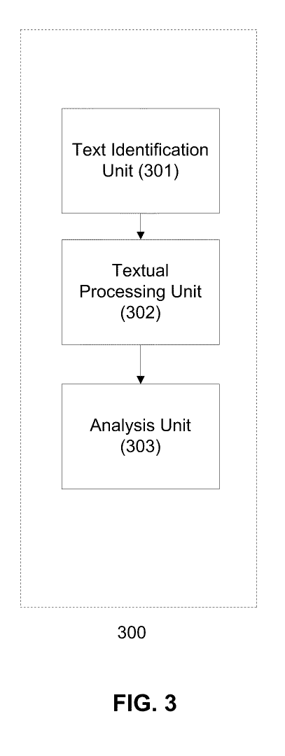

FIG. 3 illustrates a diagrammatic representation of a readability processor in accordance with an embodiment of the present disclosure.

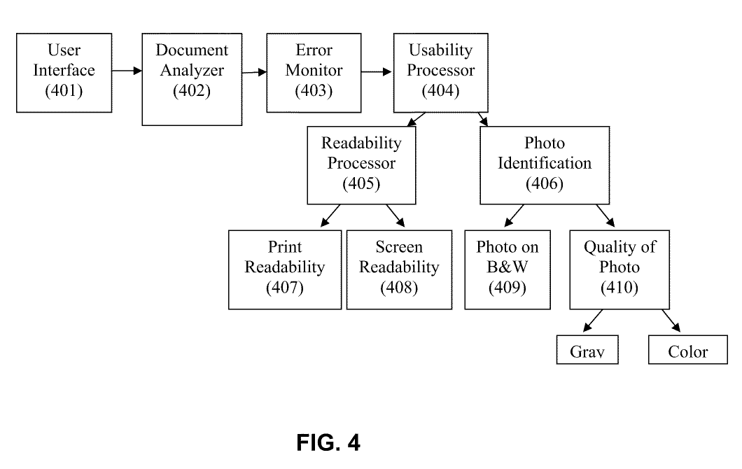

FIG. 4 illustrates a diagrammatic representation of a usability processor in accordance with yet another embodiment of the present disclosure.

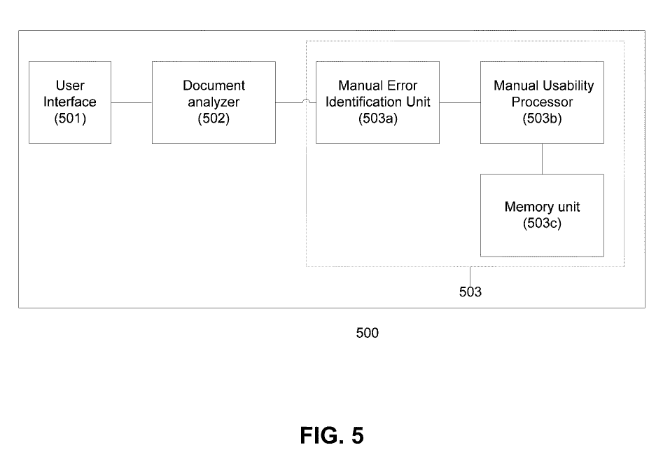

FIG. 5 illustrates a diagrammatic representation of a system for automated quality assessment of scanned documents in accordance with yet another embodiment of the present disclosure.

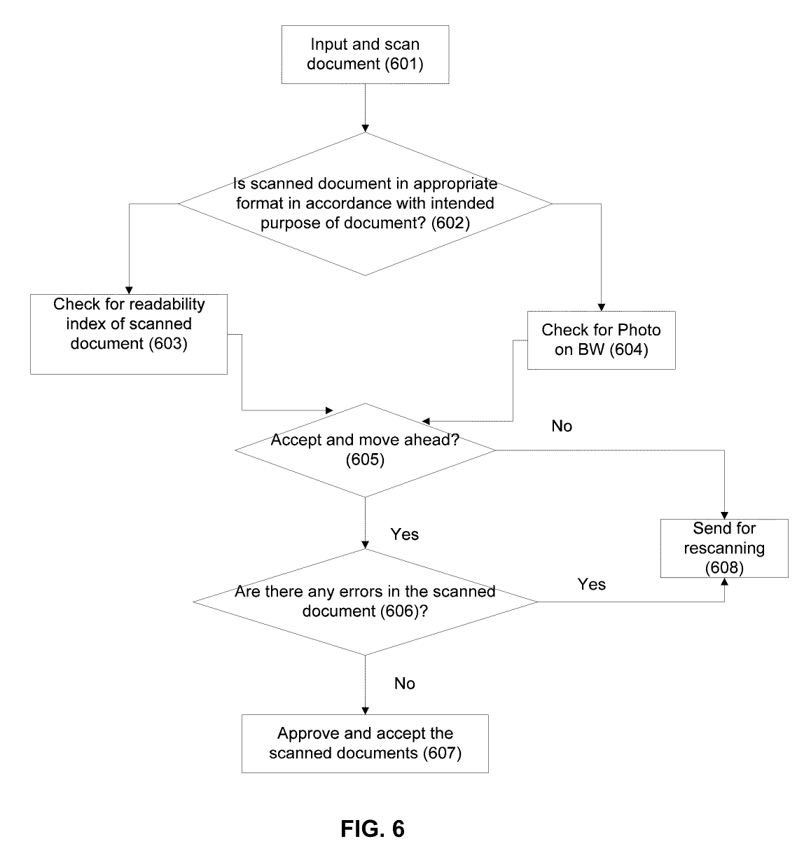

FIG. 6 illustrates a flow diagrammatic representation of a method for automated quality assessment of scanned documents in accordance with an embodiment of the present disclosure.

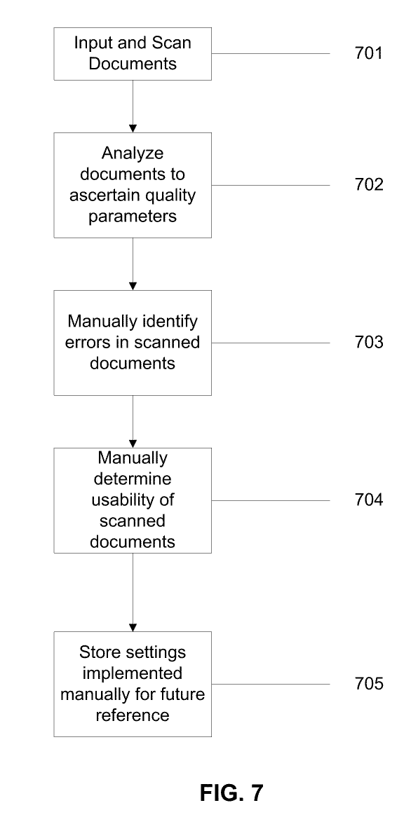

FIG. 7 illustrates a flow diagrammatic representation of a method for automated quality assessment of scanned documents in accordance with yet another embodiment of the present disclosure.

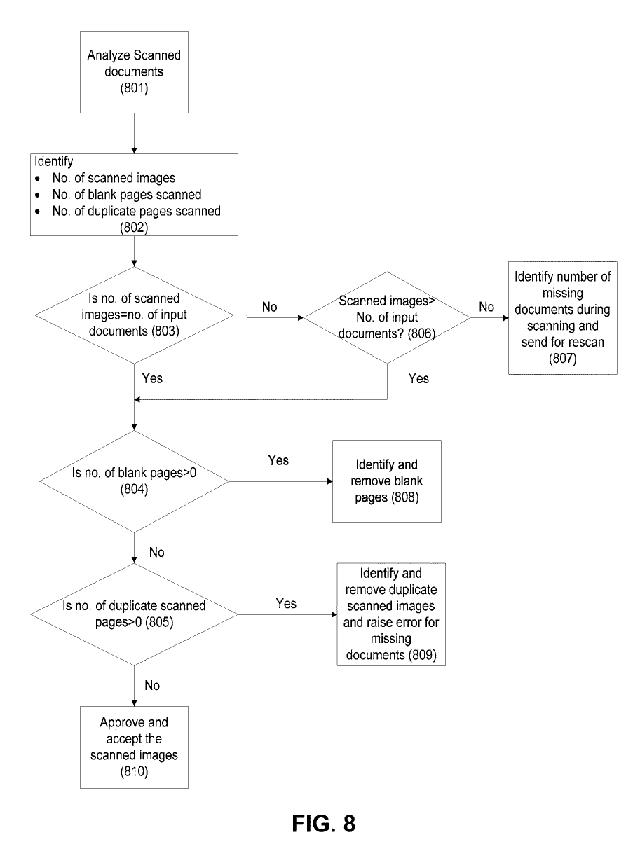

FIG. 8 illustrates a flow diagrammatic representation of a method for identifying page errors in accordance with an embodiment of the present disclosure.

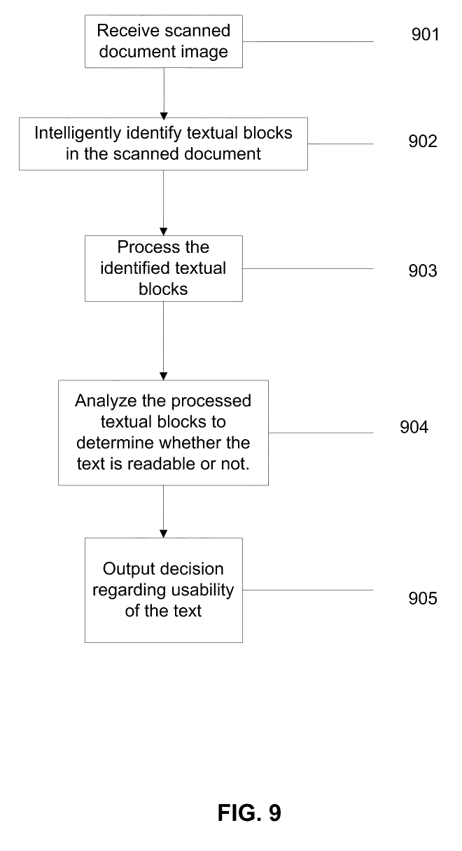

FIG. 9 illustrates a flow diagrammatic representation of a method for determining whether the scanned document qualifies readability index in accordance with an embodiment of the present disclosure.

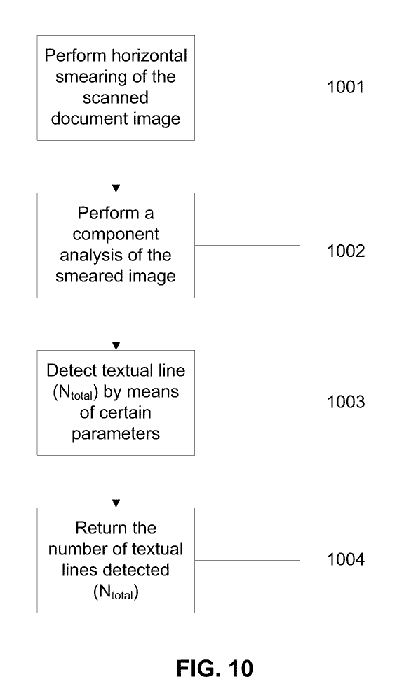

FIG. 10 illustrates a flow diagrammatic representation of a method for intelligently identifying textual blocks in a scanned document in accordance with an embodiment of the present disclosure.

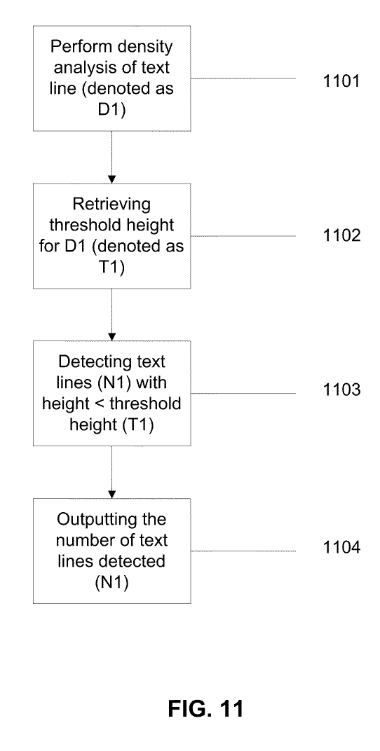

FIG. 11 illustrates a flow diagrammatic representation of a method for processing textual blocks in accordance with an embodiment of the present disclosure.

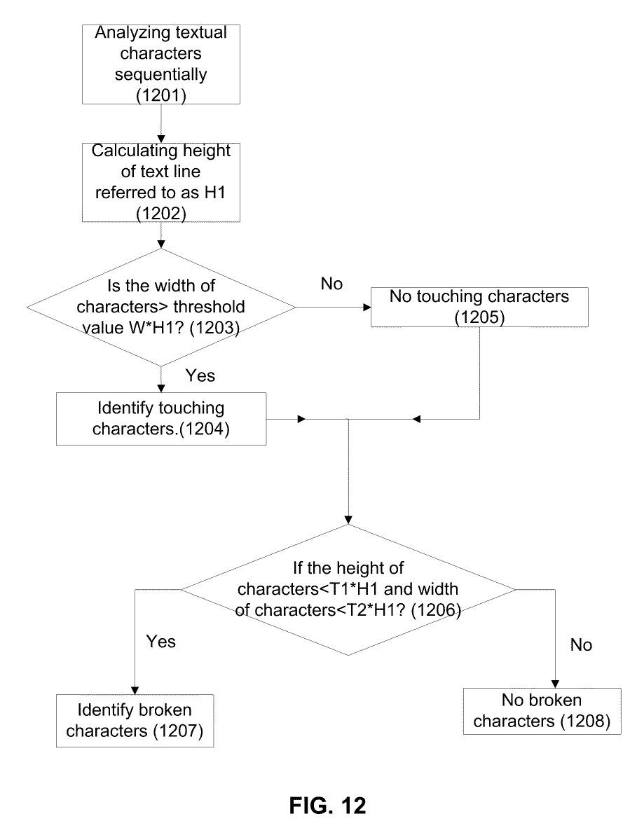

FIG. 12 illustrates a flow diagrammatic representation of a method for identifying touching or broken characters in a textual block in accordance with an embodiment of the present disclosure.

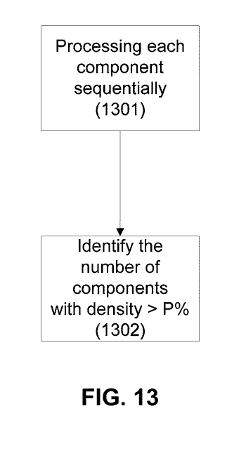

FIG. 13 illustrates a flow diagrammatic representation of a method for identifying too-dark characters in a textual block in accordance with an embodiment of the present disclosure.

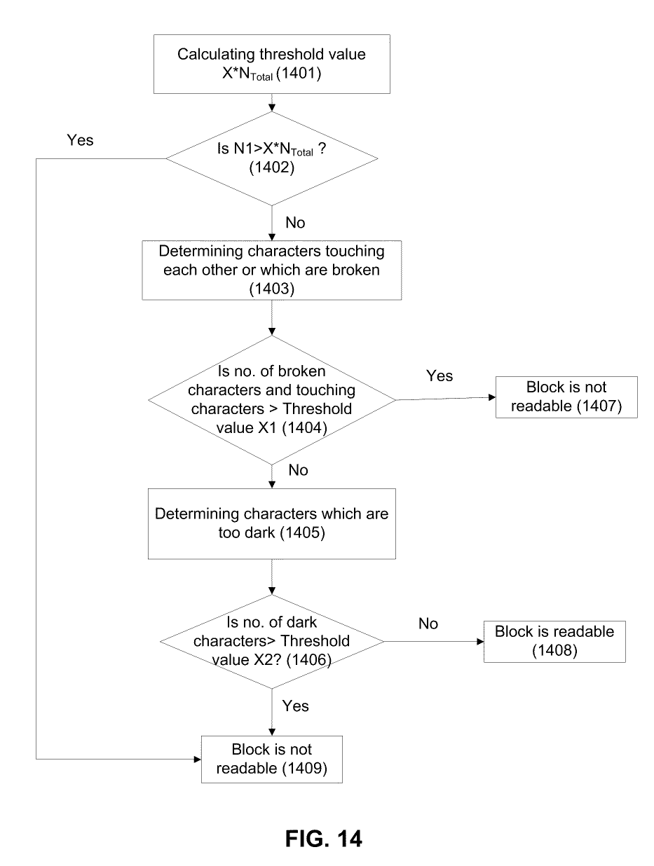

FIG. 14 illustrates a flow diagrammatic representation of a method of making a readability decision in accordance with an embodiment of the present disclosure.

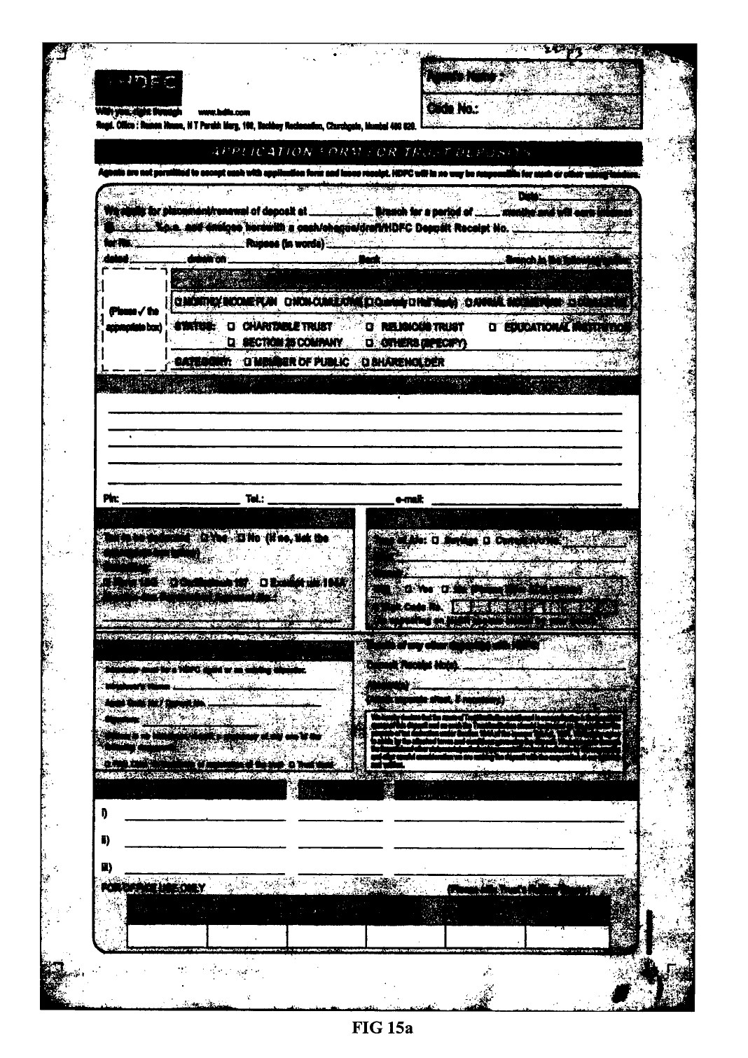

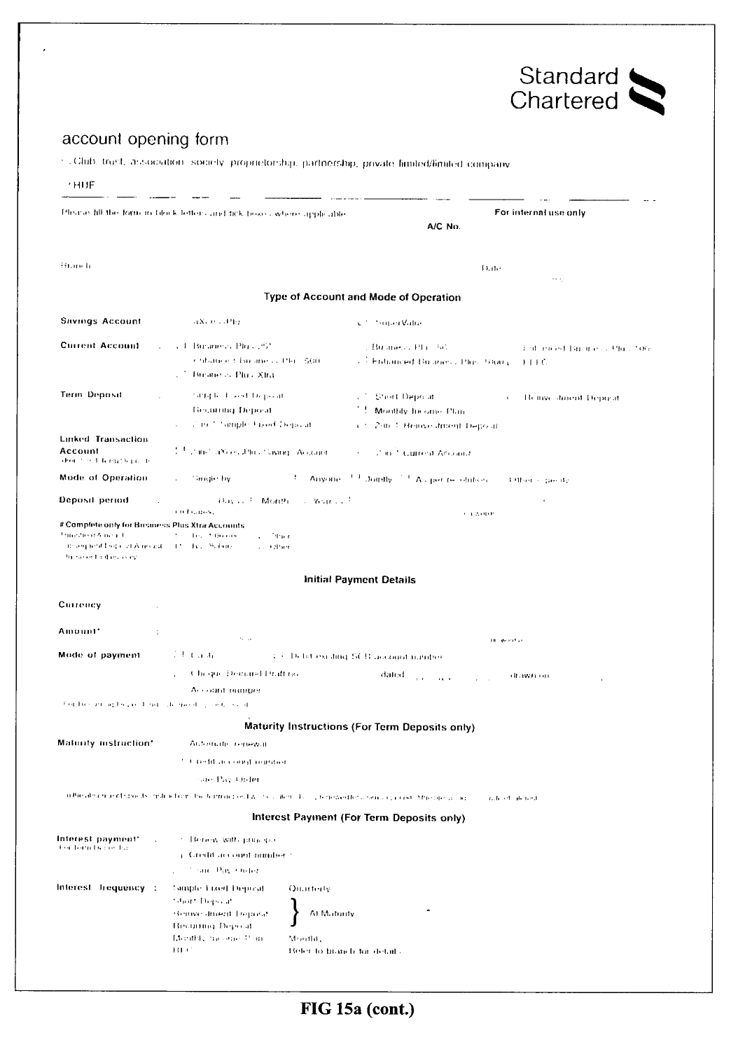

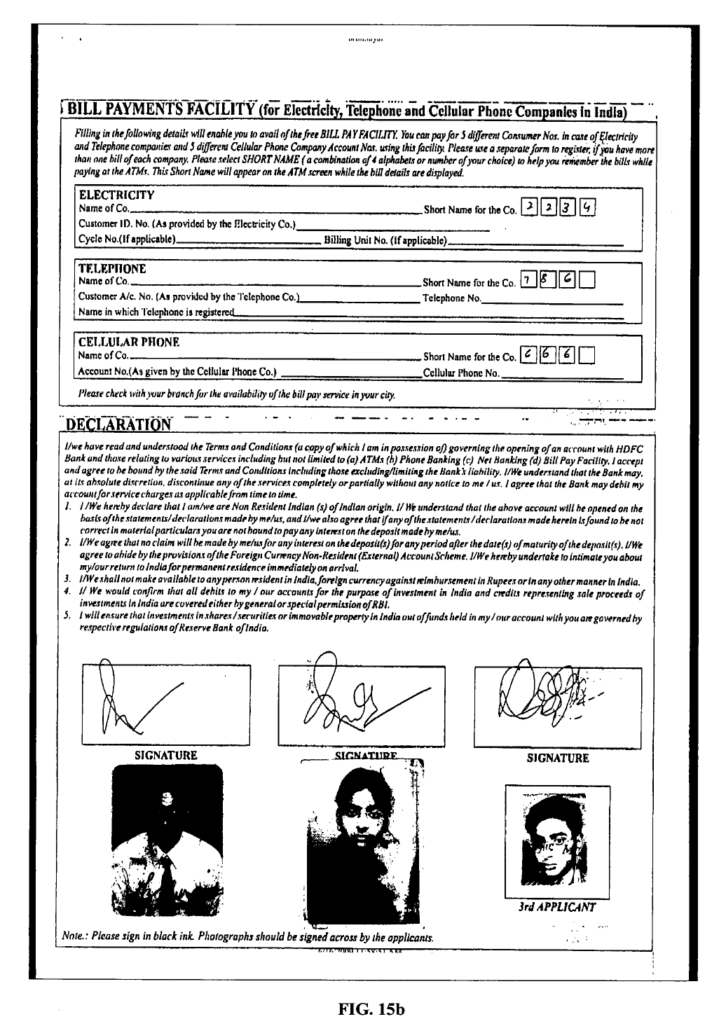

FIG. 15 illustrates examples of page errors in accordance with an embodiment of the present disclosure.

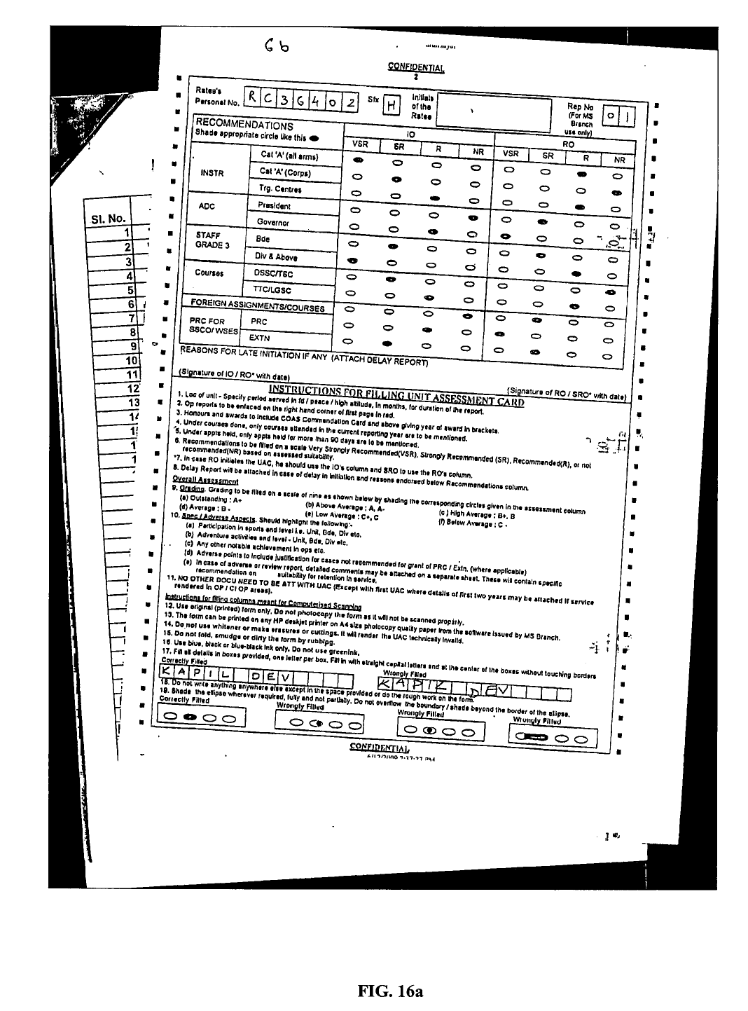

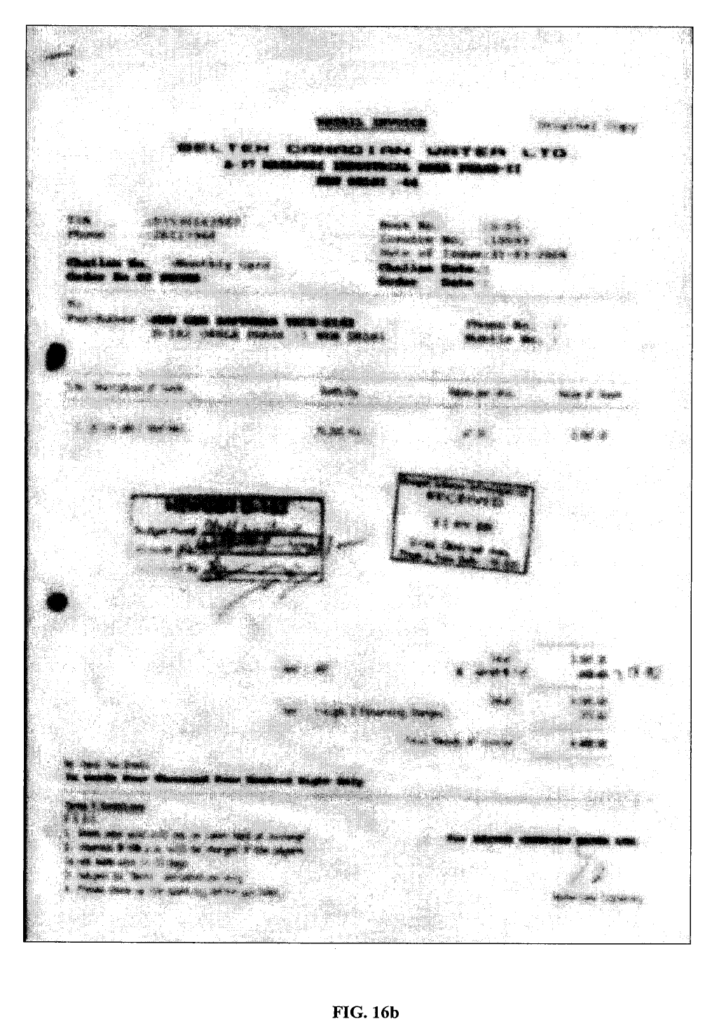

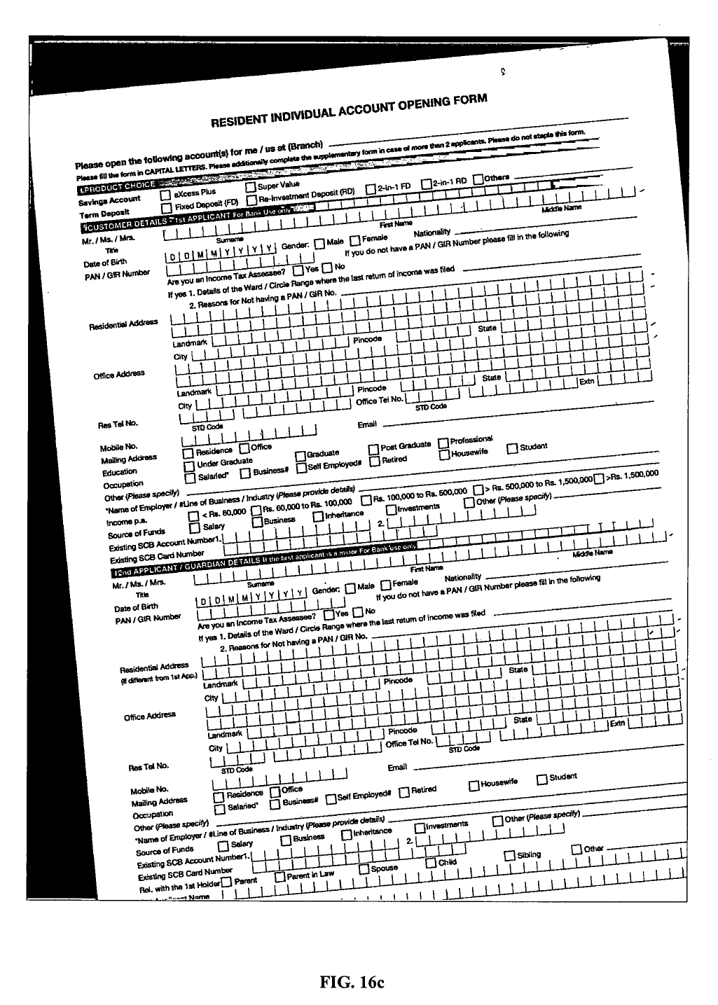

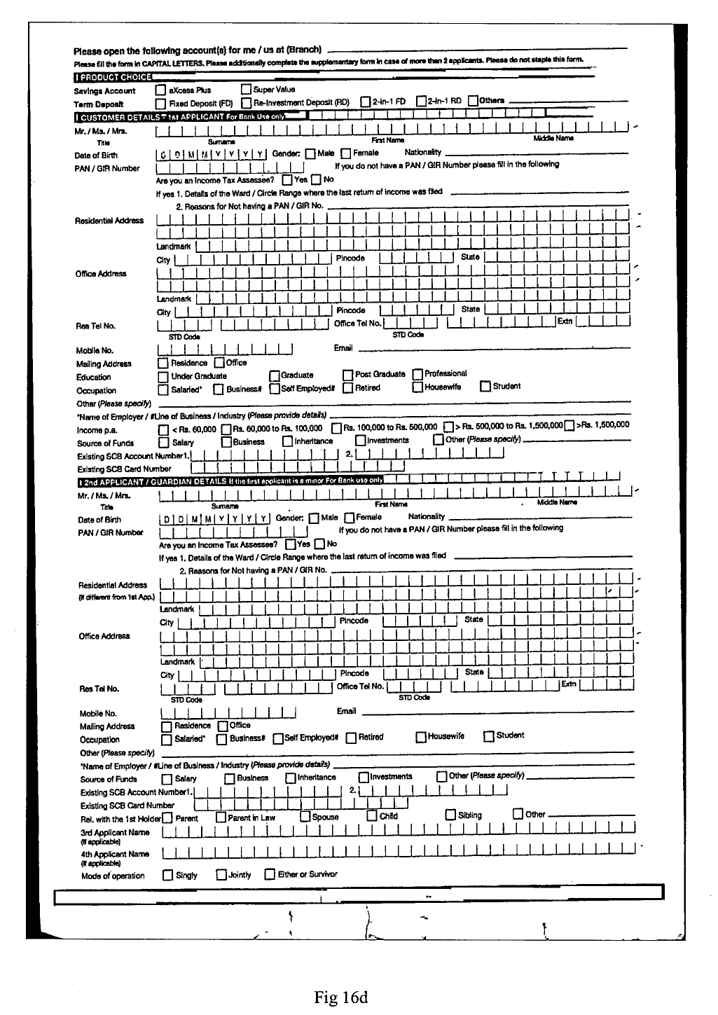

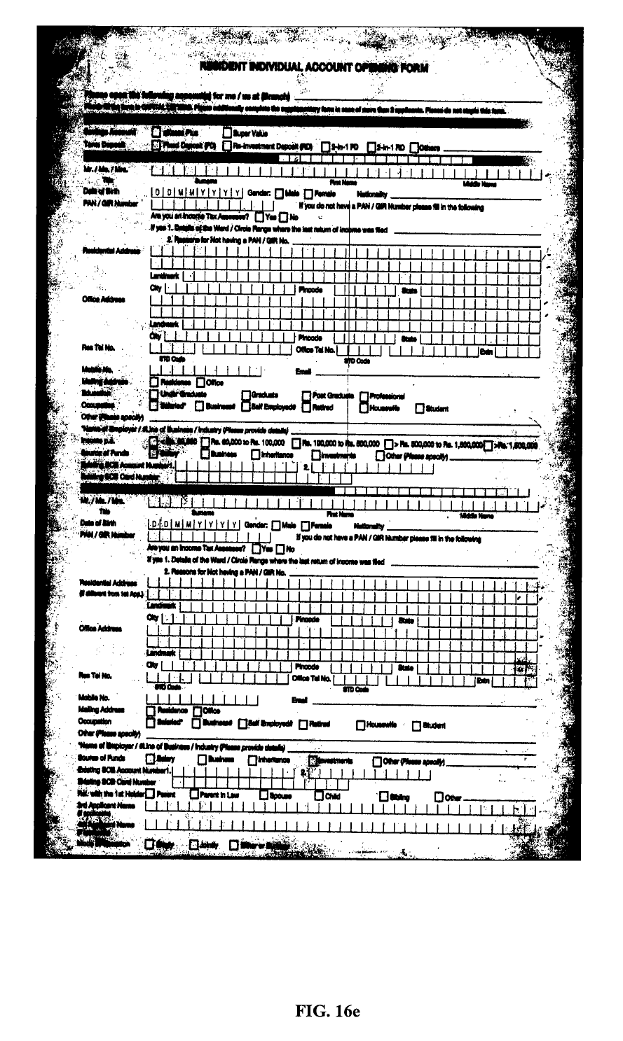

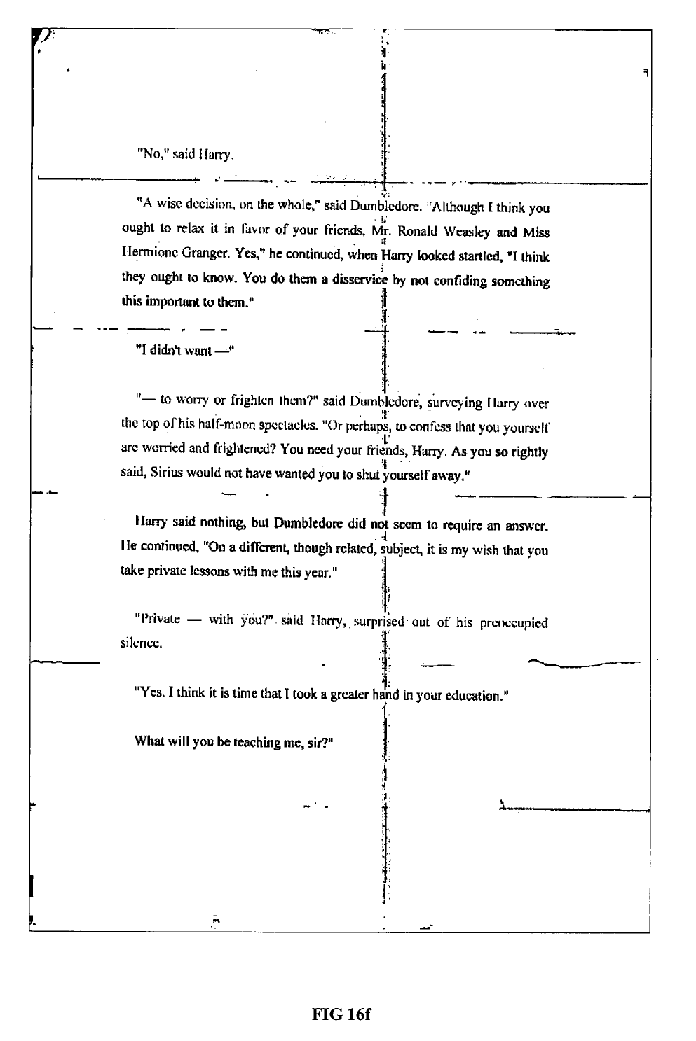

FIG. 16 illustrates examples of scanner errors in accordance with an embodiment of the present disclosure.

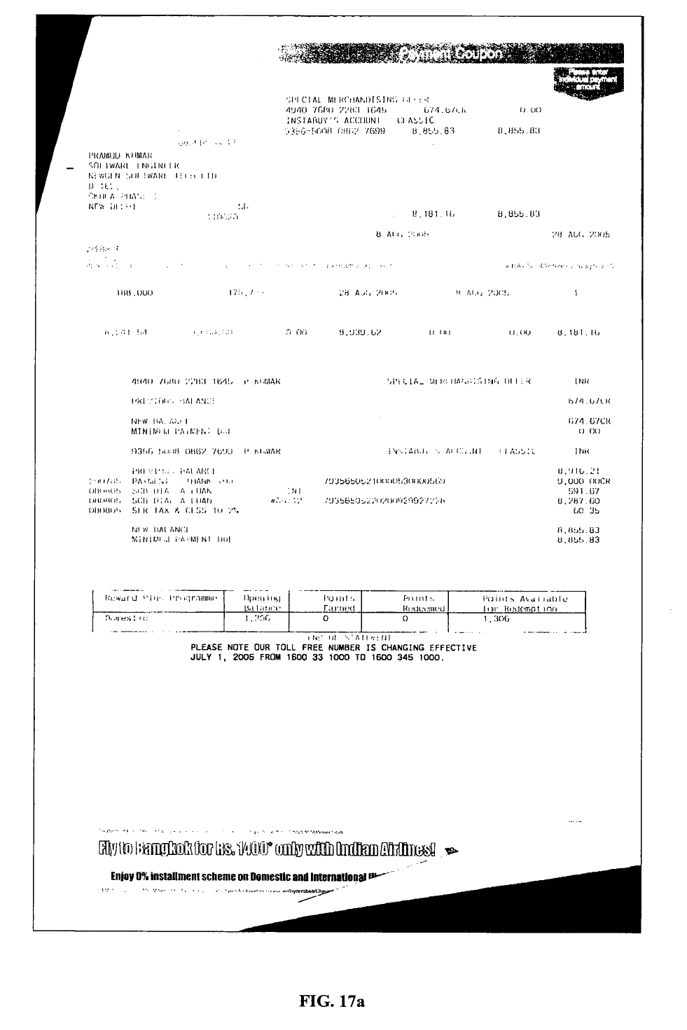

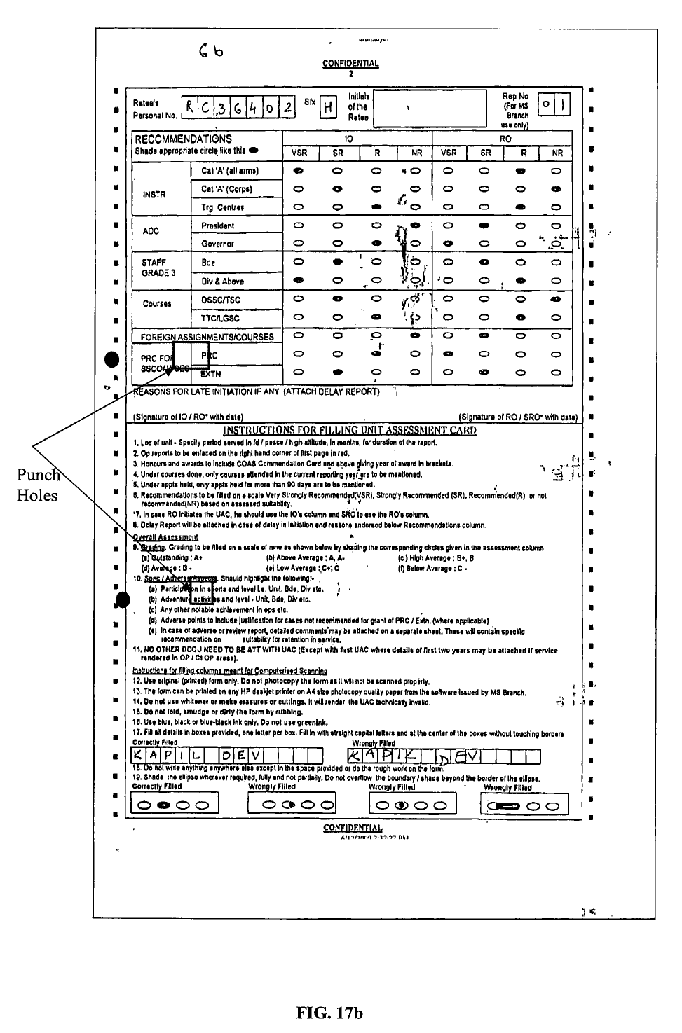

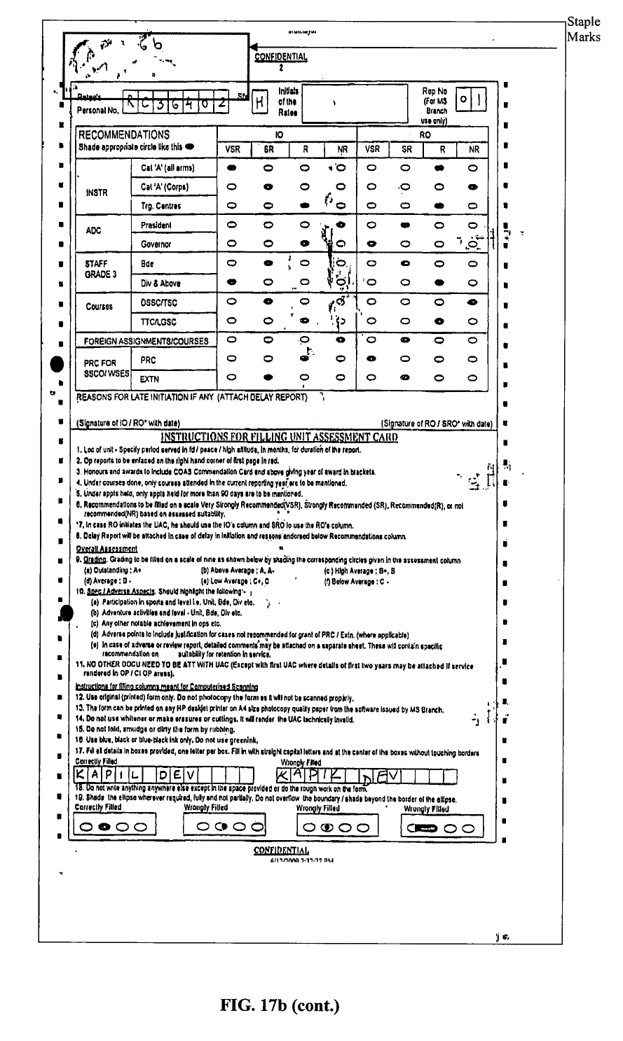

FIG. 17 illustrates examples of tangible errors in accordance with an embodiment of the present disclosure.

### DETAILED DESCRIPTION

The following discussion provides a brief, general description of a suitable computing environment in which various embodiments of the present disclosure can be implemented. The aspects and embodiments are described in the general context of computer executable mechanisms such as routines executed by a general purpose computer e.g. a server or personal computer. The embodiments described herein can be practiced with other system configurations, including Internet appliances, hand held devices, multi-processor systems, microprocessor based or programmable consumer electronics, network PCs, mini computers, mainframe computers and the like. The embodiments can be embodied in a special purpose computer or data processor that is specifically programmed configured or constructed to perform one or more of the computer executable mechanisms explained in detail below.

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures. It should be appreciated that the functions, structures, elements and the protocols used in communication are irrelevant to the present disclosure. Therefore, they need not be discussed in more detail here.

Also, all logical units described and depicted in the figures include the software and/or hardware components required for the unit to function. Further, each unit may comprise within itself one or more components which are implicitly understood. These components may be operatively coupled to each other and be configured to communicate with each other to perform the function of the said unit.

Some of the embodiments described below are specific to a usability decision pertaining to the readability of the scanned document i.e. a readability decision. However, these embodiments are not limited to the same and are applicable to the usability of a scanned document in general.

FIG. 1 illustrates a diagrammatic representation of a system for automated assessment of quality of scanned documents in accordance with an embodiment of the present disclosure. The system (100) comprises a user interface (101), a document analyzer (102), an error monitor (103) and a usability processor (104). The user interface (101) enables a user to input intended purpose of the scanned document as well as pre-determined parameters such as touching character count, font height, density, font, width skew factor, black-band ratio etc. to assess the quality of scanned documents. The document analyzer (102) is configured to analyze and ascertain whether the scanned document is in an appropriate format in accordance with the intended purpose of the scanned document.

FIG. 2 illustrates a diagrammatic representation of an error monitor in accordance with an embodiment of the present disclosure. The error monitor (200) comprises a usability error identification unit (201), a page error identification unit (202), a scanner error identification unit (203) and a tangible error identification unit (204) where all the aforementioned units are communicatively coupled to each other.

A usability error identification unit (201) identifies errors resulting when the scanned document is not readable, printable or photographs of the document are scanned in black and white. The scanned document is not readable or printable when the document is too dark, too light or is scanned at low resolution. The document cannot be used for photo identification if the documents are acquired/scanned in black and white. These are illustrated as below:
Too Dark/Too Light: The scanned image is either too light or too dark either due to Poor printing/writing contrast on the source document, improper thresholding of the document background, illumination problems with the image capture subsystem etc. (Example of the same has been illustrated in FIG. 15a)
Photograph Scanned in B-&-W: If a particular document has photographs, scanning the document in B&W does not solve the purpose as the photograph is used as an identification of the customer for all future transactions. (Example of the same has been illustrated in FIG. 15b)
Too Much White/Black: If the image is not cropped properly, it does not have proper margins and might contain too much of white or black portion.

The page error identification unit (202) is configured to identify errors arising due to blank pages or duplicate pages. The unit (202) first analyzes the scanned document and identifies the number of scanned documents, number of blank pages scanned and number of duplicate pages scanned. In case of any such identification, the blank or duplicate pages are removed such that the number of scanned document is equivalent to the number of input documents.

The scanner error identification unit (203) is configured to identify errors resulting due to incorrect scanner operations such as piggy backing, wrong placement of documents and out of focus scanning Such errors are illustrated below:
Piggy Back: A piggy-back defect occurs when two or more scanned document images are overlapped within the image. It usually occurs due to mechanical handling or control problems within the scanning unit or incase of a poor quality document. A multi feed or a double page error also occurs because of the same reasons. (Example of the same is illustrated in FIG. 16a).
Out of Focus: If the scanned document is out of focus of the scanning unit, it results in blurred image acquisition of the document. (Example of the same has been illustrated in FIG. 16b)
Skew: When the document is not in proper alignment on the scanner window, it results in a skewed document image. (Example of the same has been illustrated in FIG. 16c)
Wrong Orientation: The scanned image is aligned at a wrong angle vertically or horizontally. (Example of the same has been illustrated in FIG. 16d)
Too much Noise at the Edges: Noise can occur in the image because of physical defects on the document, improper illumination of the scanning device etc. (Example of the same has been illustrated in FIG. 16e)
Horizontal and Vertical Streaks Present in the Image: Horizontal streaks, either dark or light, extend horizontally across the majority of the entire document image. Dark streaks can be caused by factors like dirt or debris on the capture lens during the image capture process. (Example of the same has been illustrated in FIG. 16f)

The tangible error identification unit (204) is configured to identify errors arising due to the physical state of the paper document being scanned such as punch holes in the document, torn or folded edges of the document or font size of the document. These errors are illustrated below:
Folded or Torn Document Edges: This defect occurs due to the edge of the source document being either missing and/or folded during the document image acquisition. (Example of the same has been illustrated in FIG. 17a)
Punch Holes/Stapler Marks: Some documents either have punch holes or stapler marks present on them and are thus scanned with them. Our system successfully removes these and restores the original document. (Example of the same has been illustrated in FIG. 17b)

FIG. 3 illustrates a readability processor in accordance with an embodiment of the present disclosure. The readability processor comprises a text identification unit (301), a textual processing unit (302) and an analysis unit (303). The text identification unit (301) is required to intelligently identify text blocks from the scanned document which are consequently, input to the textual processing unit (302), which processes the identified textual blocks. These textual blocks are processed by determining the height, width and density of the textual block and thereby segregating the text with smaller font and greater density and characters which are touching or broken. The analysis unit (303) on basis of the processed textual blocks makes a usability decision i.e. whether the text is usable for readability, printing etc.

FIG. 4 illustrates a usability processor (400) in accordance with yet another embodiment of the present disclosure. The usability processor comprises a user interface (401) coupled to a document analyzer (402). The user interface enables a user to input predetermined parameters as well as intended purpose of the document such that analysis by the document analyzer is effective. The document analyzer shall determine whether the document is in a format suitable for the intended purpose as input by the user. Consequently, the output of the document analyzer is further coupled to an error monitor (403), which is coupled to a usability processor (404). The error monitor processes the scanned document to determine whether there are any errors in the document. The usability processor in turn then, makes a usability decision regarding the scanned document. A readability processor (405) and a photo identification unit (406) are coupled to the usability processor (404) to check the scanned document for print readability (407), screen readability (408), photo in B&W (409) and Quality of the photo (410). The quality of the photo is judged on basis of gray sequenced photograph and color sequenced photograph. This check is due to the fact that there are various applications which require a photograph of a user. However, many a times due to the scanned version being in Black and White (BW) it is difficult for a user to verify the identity of the person.

FIG. 5 refers to a system for automated quality assessment of scanned documents in accordance with yet another embodiment. One or more sample documents of a type are fed to the system (500) to determine the correct range of values of the configurable parameters. The system (500) comprises a user interface (501), a document analyzer (502) and a training module (503). The user interface (501) enables a user to input the intended purpose of a scanned document and enter pre-determined parameters to assess the quality of the scanned document. These parameters are configurable by the user at a later stage as well. The document analyzes the scanned document to determine whether the document is in appropriate format in accordance with the intended purpose of the scanned document. If it is appropriate the user then checks the scanned document manually through the training module (503). The training module comprises a manual error identification unit (503a), a manual usability processor (503b) and a memory unit (503c). The user manually checks through the error identification unit (503a) for any errors in the scanned document such as usability errors, page errors, scanner errors or tangible errors. Accordingly, the user determines the readability index through the usability processor (503b) and makes a usability decision as to whether the scanned document is usable or not. The decision and the configurations of the parameters are then stored in the memory unit (503c) for future reference. Consequent to the training of the system via the training module after a few initial batches of documents for scanning, the system becomes automatic and functions as described in embodiment described in FIG. 1 of the present disclosure.

### Exemplary Embodiment

To illustrate the embodiments in accordance with the present disclosure as described in FIGS. 1, 2, 3 and 4, we assume that forms for opening an account are being scanned for documentation at a bank. A user through the user interface inputs that the intended purpose of the scanned document is identity verification and the appropriate format that is to be followed in respect of the same.

Then, the paper document is scanned and the scanned document is analyzed by means of the document analyzer which verifies whether the scanned document is in appropriate format in accordance with the intended purpose of the scanned document or in accordance with yet another embodiment, the format as has been requested for by a client. If the scanned document is in appropriate format, the scanned document goes through the error monitor wherein the scanned document is checked for usability errors, page errors, scanner errors and tangible errors. Therefore, if the paper document during scanning has been folded, the scanner error identification unit would identify the same and alert the user. Also, if the photographs on the forms are in black and white then the usability error identification unit would alert the user of the same as it would be easier for the bank to verify the identity of a person if the photographs are in color. If there are punch holes or staple marks in the document, the tangible error identification unit will alert the user as these marks may at a later stage produce problems.

After the errors have been detected and dealt with, the scanned document is forwarded through the usability processor which helps make a usability decision. If the intended usage of the document is readability decision, the text identification unit intelligently identifies textual blocks from the scanned document, which are then processed by a textual processing unit wherein the height, density and width of the textual line are determined. The textual blocks with height smaller or bigger than the threshold range of height, width and density of characters are segregated and on basis of the total number of such characters in comparison to the total number of characters, the usability decision is made by the analysis unit. Therefore, it is deciphered whether the scanned document is readable or not and whether it may be relied on or that the document needs to be sent for rescanning On the other hand, if the intended usage is photo identification, the analysis unit checks for the presence of photo in Black-&-White or the quality of color or gray image.

Embodiments of the method for automated quality assessment of scanned documents according to various embodiments of the present disclosure are described in FIGS. 6, 7, 8, 9, 10, 11, 12, 13 and 14. The methods are illustrated as a collection of blocks in a logical flow graph, which represents a sequence of operations that can be implemented in hardware, software, or a combination thereof. The order in which the process is described is not intended to be construed as a limitation, and any number of the described blocks can be combined in any order to implement the process, or an alternate process.

FIG. 6 illustrates a method for automated quality assessment of scanned documents in accordance with an embodiment of the present disclosure. The method comprises input and scanning of a document (601) and verifying whether the scanned document is in appropriate format or not in accordance with the intended purpose of the document (602). If the scanned document is in appropriate format then the scanned document is checked for readability (603) as well as for photo on BW i.e. Black and white (604) as per its intended usage. If within the mentioned criteria, the document is accepted (605) the next step is followed else the document is sent for rescanning (608). The accepted document is then checked for errors (606). If there are no errors identified in the scanned document, it is then approved and accepted (607) else the document is sent for rescanning (608).

The step of checking for errors in the scanned document (606) further comprises identification of usability errors, page errors, scanner errors and tangible errors. The usability errors result due to errors when the scanned document is not readable, printable or photographs of the document are scanned in black and white. The page errors are errors arising due to blank pages and duplicate pages. The scanner errors are errors arising due to incorrect scanner operations such as piggy backing, wrong placement of documents and out of focus scanning. The tangible errors are errors arising due to state of the document being scanned such as punch holes in the document, torn or folded edges of the document and font size of the document.

FIG. 7 refers to a method for automated quality assessment of scanned document in accordance with yet another embodiment of the present disclosure. It describes the dynamic configuration of the system by the user in the training module according to an embodiment of the present disclosure. A sample document is input and scanned (701) and analyzed to ascertain the quality in accordance with the intended purpose of the document (702). Then the user manually identifies errors in the scanned document if any (703). Consequently, the scanned document is checked manually by the user for usability of the scanned document (704). According to example of the present embodiment, the user manually identifies the readability index of the scanned document. The user then stores the configurable parameters as specified during manual error identification and readability index detection in a memory unit (705). These parameters are then used for future reference for scanning of documents of the same type. On completion of training of the system after a few initial batches of documents for scanning, the method of quality assessment becomes automated wherein no manual intervention is needed.

FIG. 8 refers to a method for identifying page errors in the scanned documents in accordance with an embodiment of the present disclosure. The scanned documents (801) are analyzed and the number of scanned documents, blank pages scanned and duplicate pages scanned are identified (802). The number of scanned documents is then compared to the number of input documents. In accordance with an embodiment of the disclosure, the number of input documents is identified by indexing and checking the barcode of each document which helps account for the number of file sets/documents that have been submitted to a particular batch of documents. If the number of scanned documents is equivalent to the number of input documents (803), the number of blank pages is identified else, it is verified whether the number of scanned documents is greater than the number of input documents (806). If the number of scanned documents is greater then the number of blank pages is identified (804) else the number of missing pages is identified and rescanned (807). Further, if there are any blank pages identified (804), the blank pages are removed (808) else it is verified whether there are any duplicate scanned pages (805). If there are none, there are no page errors and therefore, the scanned documents are approved and accepted (810) else the duplicate scanned pages are removed and an error for missing documents is raised (809).

The step of verifying whether the scanned document qualifies the readability index or not in accordance with an embodiment of the present disclosure is illustrated in FIG. 9. The scanned documents are received (901) and textual blocks are intelligently identified (902) and processed (903). The processed textual blocks are analyzed to determine whether the text is usable or not (904). Accordingly, the decision regarding usability of the text is output (905).

FIG. 10 refers to a method for intelligently identifying textual blocks in accordance with an embodiment of the present disclosure. Horizontal smearing on the image is performed (1001) by a factor of S* XDPI, the dpi value in X-direction. Component analysis is then performed on the smeared image (1002) and Nₜₒₜₐₗ is then calculated (1003) on the basis of various features like height, density, width etc. the components and returned (1004).

FIG. 11 refers to a method for processing the textual blocks identified in accordance with an embodiment of the present disclosure wherein density analysis of text lines is performed (1101), D1 being the density of the first text line. The corresponding threshold height T1, pre-calculated and stored by experimentation, for D1 is retrieved (1102) and text lines with maximum height less than the threshold height are detected (1103). These text lines are denoted by N1.

FIG. 12 refer to a method for identifying touching and broken characters in accordance with an embodiment of the present disclosure. The textual characters are analyzed sequentially (1201) and the height of text line is calculated and referred to as H1 (1202). It is then determined whether the width of the characters is greater than the threshold value of W*H1 (1203). If yes, then touching characters are identified (1204) else it is determined that there are no touching characters in the textual block (1205). Consequently, it is determined whether the height of the characters matches the threshold value of T1*H1 (1206). If the height is less than the threshold value, then broken characters are identified (1207), else it is determined that there are no broken characters (1208).

FIG. 13 refers to a method to detect components with too-dark density in accordance with an embodiment of the present disclosure. Accordingly, sequential processing of each component is performed (1301) followed by segregation of the components with density greater than P % (by experimentation) (1302).

FIG. 14 refers to a method for making a usability decision in accordance with an embodiment of the present disclosure. The embodiment describes the usability decision made on readability of a textual block. However, the present disclosure is not limited to the same. The threshold value of X*Nₜₒₜₐₗ is calculated (1401) and it is determined whether the number of segregated characters N1 exceeds the threshold value (1402). If yes, then the block is not readable (1409) else, the number of touching and broken characters is determined (1403). It is then determined whether the number of touching and broken characters exceeds the threshold value X1 (1404). If yes, then the block is not readable (1407) and further processing to make a readability decision stops, else characters with too-dark density are determined (1405). If the number of such characters is greater than the threshold value of X2 (1406) then the block is not readable (1409) and further processing stops else the scanned document is rendered readable (1408).

Various embodiments of the present disclosure ensure that the scanning happens as per the requirements of the client, and the scanning quality is not compromised by scanning the documents into some lossy format or at low resolution.

The present disclosure describes unique sets, each comprising specific parameters and specific parameter values to gauge the image quality of the document. Once the quality is known, the document can either be accepted for further processing or a request can be immediately sent to rescan the poor-quality document. This ensures that poor-quality document images are caught at the earliest in the process and immediate action can be taken. This results in huge gain for the organization, as it is not faced with scenarios where poor quality of document image is determined only when it is to be actually used. At that time, since the scanned document image is of no use, not only business opportunity is lost; but tracking the original document for rescanning is another resource, time and cost-intensive exercise.

As will be appreciated by one of skill in the art, the present invention may be embodied as a method, system, or computer program product. Accordingly, the present invention may take the form of an entirely hardware embodiment, a software embodiment or an embodiment combining software and hardware aspects all generally referred to herein as a “circuit” or “module.” Furthermore, the present invention may take the form of a computer program product on a computer-usable storage medium having computer-usable program code embodied in the medium.

Furthermore, the present invention was described in part above with reference to flowchart illustrations and/or block diagrams of methods, apparatus (systems) and computer program products according to embodiments of the invention.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and schematic diagrams of FIGS. 1-16 illustrate the architecture, functionality, and operations of some embodiments of methods, systems, and computer program products for media tuning In this regard, each block may represent a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

In the drawings and specification, there have been disclosed exemplary embodiments of the invention. Although specific terms are employed, they are used in a generic and descriptive sense only and not for purposes of limitation, the scope of the invention being defined by the following claims

We claim:

1. A system for automated quality assessment of scanned documents comprising:
a. a user interface;
b. a document analyzer coupled to the user interface;
c. an error monitor coupled to the document analyzer; and
d. a usability processor coupled to the error monitor.

2. The system as claimed in claim 1 wherein the error monitor comprises:
a. at least one usability error identification unit;
b. at least one page error identification unit;
c. at least one scanner error identification unit; and
d. at least one tangible error identification unit where said units are communicatively coupled to each other.

3. The system as claimed in claim 1 wherein the usability processor comprises:
a. at least one text identification unit;
b. at least one textual processing unit coupled to the text identification unit;
c. at least one image analysis unit coupled to the textual processing unit; and
d. at least one photo assessment unit coupled to the analysis unit.

4. The system as claimed in claim 1 wherein the user interface is configured to receive user input that specifies an intended purpose of scanned document and user input specifying predetermined parameters to assess quality of scanned documents.

5. The system as claimed in claim 4 wherein the predetermined parameters include at least one parameter selected form the group of parameters consisting of touching character, font height, density, font and width, too-light or too-dark, folded torn edges, folded torn corners.

6. The system as claimed in claim 1 wherein the document analyzer is configured to analyze the scanned document and ascertain whether the scanned document is formatted in accordance with a specified intended purpose of scanned document.

7. The system as claimed in claim 2 wherein the usability error identification unit is configured to identify errors corresponding to a set of errors consisting of the scanned document not being readable; the scanned document not being printable and the scanned document being a black and white scan of a photograph.

8. The system as claimed in claim 2 wherein the page error identification unit is configured to identify errors corresponding to blank pages or duplicate pages.

9. The system as claimed in claim 2 wherein the scanner error identification unit is configured to identify errors corresponding to incorrect scanner operations the errors being identified from a group of errors consisting of piggy backing, wrong placement of documents, and out of focus scanning.

10. The system as claimed in claim 2 wherein the tangible error identification unit is configured to identify errors arising due to physical state of the document being scanned the errors being identified from a group of errors comprising punch holes in the document, torn or folded edges of the document and font size of the document.

11. The system as claimed in claim 3 wherein the text identification unit is configured to identify textual blocks in the scanned document.

12. The system as claimed in claim 3 wherein the textual processing unit is configured to process the identified textual blocks to determine height, density and width of the textual blocks.

13. The system as claimed in claim 3 wherein the analysis unit is configured to determine whether the scanned document is usable for a specified purpose.

14. The system as claimed in claim 3 wherein the photo assessment unit comprises:
a. at least one black and white detection unit; and
b. at least one photo quality analysis unit coupled to the black and white detection unit.

15. A system for automated quality assessment of scanned documents comprising:
a. a user interface;
b. a document analyzer coupled to the user interface; and
c. a training module coupled to the document analyzer.

16. The system as claimed in claim 15 wherein said training module comprises:
a. a manual error check unit;
b. a manual usability processor coupled to the manual error check unit; and
c. a memory unit coupled to the manual usability processor.

17. The system as claimed in claim 15 wherein the user interface is configured to receive, from a user, input specifying an intended purpose of a scanned document and user input specifying pre-determined parameters to assess quality of scanned documents such that they pre-determined parameters are configurable by the user.

18. The system as claimed in claim 17 wherein the pre-determined parameters include at least one parameter selected from a group of parameters consisting of—touching character, font height, density, font, width, too dark, too-light, folded torn edges, folded torn corners, skew.

19. The system as claimed in claim 15 wherein the document analyzer is configured to analyze a scanned document and ascertain whether the scanned document is in formatted in accordance with a specified intended purpose of scanned document.

20. The system as claimed in claim 16 wherein the manual error identification unit is configured to enables a user to specify errors in the scanned document.

21. The system as claimed in claim 16 wherein the usability processor is configured to enables a user to speccify the usability of a scanned document for readability, printability or photo identification.

22. The system as claimed in claim 16 wherein the specified errors and readability and printability index are stored in the memory unit for future reference.

23. The system as claimed in claim 15 wherein the system is configured as an automated system in response to completion of training using the training module.

24. A scanner comprising:
a. a user interface;
b. a document analyzer coupled to the user interface;
c. an error monitor coupled to the document analyzer; and
d. a usability processor coupled to the error monitor.

25. The scanner as claimed in claim 24 wherein the error monitor comprises:
a. at least one usability error identification unit;
b. at least one page error identification unit;
c. at least one scanner error identification unit; and
d. at least one tangible error identification unit,
wherein said units are communicatively coupled to each other.

26. The scanner as claimed in claim 24 wherein the usability processor comprises:
a. at least one text identification unit;
b. at least one textual processing unit coupled to the text identification unit; and
c. at least one analysis unit coupled to the textual processing unit.

27. The scanner as claimed in claim 24 wherein the usability processor comprises:
a. at least one text identification unit;
b. at least one textual processing unit coupled to the text identification unit;
c. at least one analysis unit coupled to the textual processing unit; and
d. at least one photo assessment unit coupled to the analysis unit.

28. The scanner as claimed in claim 24 wherein the user interface is configured to receive user input specifying an intended purpose of a scanned document user input that configures pre-determined parameters that assess quality of scanned documents.

29. The scanner as claimed in claim 28 wherein the predetermined parameters include at least one parameter selected form a group of parameters consisting of touching character, font height, density, font and width, too-light or too-dark, folded torn edges, folded torn corners.

30. The scanner as claimed in claim 24 wherein the document analyzer is configured to analyze a scanned document and ascertain whether the scanned document is formatted in accordance with a format corresponding to an intended purpose of scanned document.

31. The scanner as claimed in claim 25 wherein the usability error identification unit is configured to identify errors corresponding to a scanned document that is not readable; or printable or a scanned document that is a black and white scan of a photograph.

32. The scanner as claimed in claim 25 wherein the page error identification unit is configured to identify errors corresponding to blank pages, missing pages or duplicate pages.

33. The scanner as claimed in claim 25 wherein the scanner error identification unit is configured to identify errors corresponding to incorrect scanner operations selected from a group consisting of piggy backing, wrong placement of documents and out of focus scanning.

34. The scanner as claimed in claim 25 wherein the tangible error identification unit is configured to identify errors corresponding to physical state of a document being scanned the identified errors including at least one of -punch holes in the document, torn or folded edges of the document and font size of the document.

35. The scanner as claimed in claim 27 wherein the text identification unit is configured to identify textual blocks in a scanned document.

36. The scanner as claimed in claims 27 wherein the textual processing unit is configured to process the identified textual blocks to determine height, density and width of the textual blocks.

37. The scanner as claimed in claims 27 wherein the analysis unit is configured to determine whether a scanned document is usable for a specified intended purpose.

38. The system as claimed in claim 27 wherein the photo assessment unit comprises:
a. at least one black and white detection unit; and
b. at least one photo quality analysis unit coupled to the black and white detection unit.

39. A method for automated quality assessment of scanned documents comprises:
a. receiving a scanned document;
b. determining whether the scanned document is formatted in accordance with a specified intended purpose of the scanned document;
c. identifying errors in the scanned document;
d. making a usability decision regarding the scanned document based on the identified errors; and
e. approving and accepting the scanned document in response to a usability decision specifying that the scanned document is usable for the intended purpose; and
f. rejecting the scanned document in response to a usability decision that the scanned document is not usable for the intended purpose.

40. The method as claimed in claim 39 wherein identifying any errors in the scanned document comprises:
a. identifying usability errors;
b. identifying page errors;
c. identifying scanner errors; and
d. identifying tangible errors.

41. The method as claimed in claim 40 wherein the usability errors are errors corresponding to -the scanned document being not readable, not printable or the scanned document being a black and white scan of a photograph.

42. The method as claimed in claim 40 wherein the page errors are errors that correspond to blank pages and duplicate pages.

43. The method as claimed in claim 40 wherein the scanner errors are errors that correspond to incorrect scanner operations selected from a group consisting of piggy backing, wrong placement of documents and out of focus scanning.

44. The method as claimed in claim 40 wherein the tangible errors are errors corresponding to physical state of the document being scanned, the physical state being at least one of punch holes in the document, torn edges of the document, folded edges of the document and font size of the document.

45. The method as claimed in claim 39 wherein making a usability decision comprises:
a. identifying textual blocks from the text extracted;
b. processing the textual blocks as identified-; and
c. analyzing the processed textual block to determine whether the text is usable for a specified intended purpose.

46. The method as claimed in claim 39 wherein making a usability decision comprises:
a. identifying textual blocks from the text extracted;
b. processing the textual blocks as identified-;
c. analyzing the processed textual block to determine whether the text is usable; and
d. assessing a photograph in the scanned document.

47. The method as claimed in claims 45 wherein processing the textual blocks as detected comprises:
determining height, width and density, broken character count, joined character count, of the textual blocks; and
identifying readability of the textual blocks based on pre-determined parameters.

48. The method as claimed in claim 46 wherein assessing a scanned document that includes a scan of a photograph comprises:
a. detecting black and white on the scan of the photo; and
b. analyzing the quality of the scan of the photo.

49. A method for automated quality assessment of scanned documents comprises:
a. receiving a scanned document;
b. analyzing the scanned document manually to ascertain quality parameters;
c. identifying errors manually in the scanned document-;
d. determining usability of the scanned document-;
e. storing settings implemented manually for future reference; and
f. analyzing scanned documents automatically using the stored settings.
